(19) United States
(12) Patent Application Publication
(10) Pub. No.: US 2013/0085955 A1
(43) Pub. Date: Apr. 4, 2013

(54) SYSTEMS AND METHODS FOR MANAGING LEARNING MATERIALS

(71) Applicant: Peter Dugas, Athens, GA (US)

(72) Inventor: Peter Dugas, Athens, GA (US)

(21) Appl. No.: 13/250,441

(22) Filed: Sep. 30, 2011

(51) Int. Cl. G06Q 50/20

(52) U.S. Cl. 705/326

(57) ABSTRACT

Systems and methods for locating recommended learning materials for students based on attributes associated with other students are presented. Exemplary methods may include building profiles associated with multiple students and assigning a score to each profile based on similarities between students. Profiles may include personal attributes identifying each respective student. A peer group of a student may be determined based on a threshold score representing a similarity between the profiles, and learning materials accessed by students within the peer group may be identified. Various search parameters may also be included in identifying learning materials, such as a course subject, or student preferences. Recommended learning materials may be identified based on various criteria including weighting access by students who receive high test scores, considering a number of times that the material has been accessed, and/or considering the creator of the resource.

### TECHNICAL FIELD

The present invention relates generally to computer networking. More specifically, the present invention relates to systems and methods for managing learning materials in a computer network environment.

### BACKGROUND OF THE INVENTION

Students, instructors, and administrators of learning institutions are constantly searching for ways to improve a student's academic performance: Students opt for tutors and purchase various texts; instructors alter lesson plans and enhance their own education; and administrators hire more experienced instructors and purchase more advanced computers and learning systems, to name a few examples. Unfortunately, these approaches and many others can be expensive and slow to implement, and the effectiveness of many of them can be difficult to measure. These approaches also rely on printed learning materials that can be expensive, outdated, or otherwise limited in their offerings on more progressive subject areas. Further compounding the problem is the fact that such inadequacies may exist in an impersonal setting. While private tutoring, for example, offers a personal setting for individualized, tailored learning, it often can be limited to a few subject areas because of expense. Thus, a way of learning that leverages proven learning materials that are widely available and cover a wide array of subject areas offered in a personalized format is desirable.

Moreover, administrators require greater transparency into which learning systems and instructors are performing according to increasing state standards. The difficulty in making such an assessment can be due to the lack of clear indicators of performance. For example, many existing learning systems and processes do not capture data related to a student's use of learning materials, some of which are authored by instructors, to analyze whether such learning materials or their authors are effective. Without this level of transparency, it can be difficult for administrators to assess whether and where to spend funds within an educational system. Furthermore, it can be cumbersome to implement the best practices of an outperforming institution across underperforming institutions. Thus, in addition to offering effective learning materials to improve a student's academic performance, a learning system that offers greater transparency into and analysis of the performance of its resources, including people, systems and materials, is desirable.

### SUMMARY OF THE INVENTION

The present invention relates generally to computer networking. More specifically, the present invention relates to systems and methods for managing learning materials in a computer network environment.

According to first aspects of the invention, a method for locating recommended learning materials may include one or more steps of building a profile associated with each student, wherein each profile comprises one or more personal attributes identifying each respective student; assigning a score to each profile associated with the student based on a similarity between the one or more personal attributes identifying the student and the one or more personal attributes identifying a target student, wherein the target student is a student for whom the learning materials are sought; determining a peer group based on a threshold score, wherein the profiles having a score above the threshold score constitute students within the peer group of the target student, wherein the threshold score represents a similarity between the profiles of the students and the target student; and/or identifying the learning materials accessed by students within the peer group.

Embodiments may include receiving a course subject as a search parameter to locate the learning materials related to the course subject. In embodiments, the score for each profile may be updated based on a comparison between test scores received by the students relative to the test scores received by the target student. In embodiments, the students who received higher test scores relative to the test scores of the target student may constitute the recommended students. Embodiments may also include identifying the learning materials accessed by the recommended students. The learning materials accessed by the recommended students may constitute the recommended learning materials.

Embodiments may include scoring the recommended learning materials based on relevance of the learning materials to the course subject. In embodiments, the relevance may be determined based on the location of keywords in files associated with the learning materials and/or the emphasis placed on the keywords. Embodiments may also include displaying the learning materials. The learning materials may be displayed, for example, according to test scores of the recommended students, the number of times the learning materials were accessed by the recommended students, and/or the duration of the access of the learning materials.

In embodiments, the keywords may be located in one or more of the meta data, text, and/or annotations in the files associated with the learning materials.

Embodiments may include equalizing test scores between students attending different institutions. In embodiments, the equalizing may be performed, for example, by comparing curriculum standards used at the different institutions. The equalizing may, for example, ensure that a test score at one institution is comparable to a test score at another institution.

In embodiments, identifying the learning materials accessed by the students and/or recommended students may include aggregating search results from a plurality of data repositories. In embodiments, identifying the learning materials accessed by the students and/or recommended students may include screening out learning materials that the target student is, or is not, authorized to access.

According to further aspects of the invention, a computer readable storage medium may be provided including computer-executable instructions for various of the steps and/or functions described herein. For example, a computer readable storage medium may be provided including computer-executable instructions for one or more steps of building a profile associated with each student, wherein each profile comprises one or more personal attributes identifying each respective student; assigning a score to each profile associated with the student based on a similarity between the one or more personal attributes identifying the student and the one or more personal attributes identifying a target student, wherein the target student is a student for whom the learning materials are sought; determining a peer group based on a threshold score, wherein the profiles having a score above the threshold score constitute students within the peer group of the target student, wherein the threshold score represents a similarity between the profiles of the students and the target student; and/or identifying the learning materials accessed by students within the peer group.

Embodiments may include instructions for receiving a course subject as a search parameter to locate the learning materials related to the course subject; updating the score for each profile based on a comparison between test scores received by the students relative to the test scores received by the target student, wherein the students who received higher test scores relative to the test scores of the target student constitute the recommended students; and/or identifying the learning materials accessed by the recommended students, wherein the learning materials accessed by the recommended students constitute the recommended learning materials.

Embodiments may include instructions for scoring the recommended learning materials based on relevance of the learning materials to the course subject. In embodiments, the relevance may be determined based on the location of keywords in files associated with the learning materials and the emphasis placed on the keywords. Embodiments may include instructions for displaying the learning materials. In embodiments, the learning materials may be displayed according to, for example, test scores of the recommended students, the number of times the learning materials were accessed by the recommended students, and/or the duration of the access of the learning materials.

In embodiments, the keywords may be located, for example, in the meta data, text, and/or annotations in the files associated with the learning materials.

Embodiments may include instructions for equalizing test scores between students attending different institutions. Equalizing may be performed, for example, by comparing curriculum standards used at the different institutions. In embodiments, equalizing may be used, for example, to ensure that a test score at one institution is comparable to a test score at another institution.

According to further aspects of the invention, a system for managing learning materials may be provided including a server with a network access and/or access to any number of data repositories. In embodiments, the server may include, for example, a network interface for connecting to a network; a memory for storing one or more program modules; and/or a processor for executing one or more program modules.

In embodiments, the program modules may include computer-executable instructions for causing the server to perform various steps and/or functions as described herein. For example, exemplary program modules may include computer-executable instructions for causing the server to build a profile associated with each student. Each profile may include one or more personal attributes identifying each respective student. Embodiments may include instructions for the server to assign a score to each profile associated with the student based on, for example, a similarity between the one or more personal attributes identifying the student and one or more personal attributes identifying a target student. In embodiments, the target student may be a student for whom the learning materials are sought. Embodiments may include instructions for the server to determine a peer group based on a threshold score. In embodiments, profiles having a score above the threshold score may, for example, constitute students within the peer group of the target student. In embodiments, the threshold score may represent a similarity between the profiles of the students and the target student. Embodiments may include instructions for the server to identify the learning materials accessed by students within the peer group.

Embodiments may include instructions for the server to track information related to the use of the learning materials. In embodiments, the information tracked may include, for example, a number of times that the learning materials have been accessed, a user identification of the student who accessed the learning materials, and/or the duration of the access of the learning materials.

Embodiments may include instructions for the server to build a class for one or more students. In embodiments, the class may be, for example, a web page comprising links corresponding to respective learning materials identified as the recommended learning materials for the respective students.

Embodiments may include instructions for the server to receive a course subject, or other parameter, as a search parameter to locate the learning materials related to, for example, a course subject. Embodiments may include instructions for the server to update the score for each profile based on a comparison between test scores received by the students relative to the test scores received by the target student. In embodiments, students who received higher test scores relative to the test scores of the target student may constitute the recommended students. Embodiments may include instructions for the server to identify the learning materials accessed by the recommended students. In embodiments, the learning materials accessed by the recommended students may constitute the recommended learning materials.

Embodiments may include instructions for the server to score recommended learning materials based on relevance of the learning materials to a course subject. In embodiments, the relevance may be determined based on, for example, a location of keywords in files associated with the learning materials and/or an emphasis placed on the keywords. Embodiments may include instructions for the server to display the learning materials. In embodiments, the learning materials may be displayed, for example, according to test scores of the recommended students, the number of times the learning materials were accessed by the recommended students, and/or the duration of the access of the learning materials.

In embodiments, the keywords may be located, for example, in the meta data, text, and/or annotations in the files associated with the learning materials.

Embodiments may include instructions for the server to equalize test scores between students attending different institutions. In embodiments, equalizing may be performed, for example, by comparing curriculum standards, or other criteria, used at the different institutions. In embodiments, the equalizing may be used, for example, to ensure that a test score at one institution is comparable to a test score at another institution.

Embodiments may include instructions for the server to communicate with a ratings source comprising ratings assigned to the learning materials by students who accessed the learning materials. In embodiments, the ratings may be used, for example, to filter the learning materials accessed by the students in the peer group.

According to further aspects of the invention, systems and methods may include one or more steps of selecting learning materials created by one or more instructors, wherein the one or more instructors assign test scores to students who access the learning materials; weighting the learning materials based on: the number of times the learning materials were accessed by students and the test scores of the students who accessed the learning materials; and/or identifying the instructors who created the learning materials.

Embodiments may include communicating with a ratings source comprising ratings assigned to the learning materials by students who accessed the learning materials. In embodiments, the ratings may be used, for example, to filter the learning materials created by the instructors.

Additional features, advantages, and embodiments of the invention may be set forth or apparent from consideration of the following detailed description, drawings, and claims. Moreover, it is to be understood that both the foregoing summary of the invention and the following detailed description are exemplary and intended to provide further explanation without limiting the scope of the invention claimed. The detailed description and the specific examples, however, indicate only preferred embodiments of the invention. Various changes and modifications within the spirit and scope of the invention will become apparent to those skilled in the art from this detailed description.

### BRIEF DESCRIPTION OF THE DRAWINGS

The accompanying drawings, which are included to provide a further understanding of the invention, are incorporated in and constitute a part of this specification, illustrate embodiments of the invention and together with the detailed description serve to explain the principles of the invention. No attempt is made to show structural details of the invention in more detail than may be necessary for a fundamental understanding of the invention and various ways in which it may be practiced. In the drawings:

FIG. 1 is a block diagram illustrating an exemplary system for managing learning materials in accordance with certain embodiments of the invention.

FIG. 2 is a flow chart illustrating a process used to locate learning materials, according to certain embodiments of the invention.

### DETAILED DESCRIPTION OF EXEMPLARY EMBODIMENTS

It is understood that the invention is not limited to the particular methodology, protocols, etc., described herein, as these may vary as the skilled artisan will recognize. It is also to be understood that the terminology used herein is used for the purpose of describing particular embodiments only, and is not intended to limit the scope of the invention. For example, although certain embodiments including learning materials used in an academic environment and the like may be described for convenience, the invention may include information access and control without limitation to the specific academic settings described herein. It also is to be noted that as used herein and in the appended claims, the singular forms “a,” “an,” and “the” include the plural reference unless the context clearly dictates otherwise. Thus, for example, a reference to “a database” is a reference to one or more databases and equivalents thereof known to those skilled in the art.

The present invention provides systems and methods for managing learning materials. As used herein, the term “learning materials” refers generally to any materials that are used by students or others to learn a particular subject matter or topic. Examples of learning materials include live or recorded lectures (distributed in audio, video, text, or multimedia formats), books, and notes taken by students or others observing a lecture or reviewing another learning material. The learning materials can be stored in a variety of sources that can be accessed by systems and methods of the present invention. Such sources can include data repositories maintained by systems of the present invention or public or licensed data repositories maintained by external systems. The system of the present invention can track access to the learning materials to determine which students are using which learning materials and how often they are using them. This information can be stored in a database and searched to locate recommended learning materials for students.

An intelligent search algorithm can be used to locate the recommended learning materials. In one embodiment, locating these learning materials can depend on a comparison between profiles associated with students to find similarities among the students. Profiles can contain personal attributes, such as age, race, gender, primary and secondary language, and grade level. Each student's profile can be ranked or weighted according to the level of similarity the personal attributes have with the personal attributes in the profiles of other students. The intent of such comparisons and rankings is to identify students who learn similarly, as indicated by their personal attributes or other background information. Students who learn similarly as indicated by the relatedness between their profiles constitute a peer group. Students within a peer group can be further ranked or weighted according to their historical test scores. Students with relatively higher test scores can receive a higher weighting than students with relatively lower test scores. By ranking students according to their test scores, the present invention seeks to identify students who have performed well academically to serve as models for other students who may be in need of additional assistance, as indicated by their test scores or some other indication. Students who may be in need of additional assistance are referred to herein as “target students.” Model students are referred to herein as “recommended students.” Whether a student is recommended can depend on the student's performance in each course subject. For example, a student can be a recommended student for one subject but may be a target student for another, depending on the student's test scores in the subjects relative to other students.

To provide additional assistance for targets students, the search algorithm of the present invention can allow students to locate learning materials used by students who have relatively high test scores. The combination of a student's high test scores and the relatedness of that student's profile to the profile of the target student can provide an indication of the learning materials that would be helpful for the target student. The learning materials can be weighted according to their relevance to the course subject or topic for which a student desires to use them to determine the recommended learning materials. Ultimately, the learning materials can be prioritized for display according to a variety of factors, including test scores of the recommended students and the relevance of the learning materials and/or test scores received by all students who use the learning materials and by their relevance to the subject searched by the student.

The search algorithm can also provide an indication of the effectiveness of instructors and institutions by examining how often learning materials created by the instructors, and hence their institutions, are used. The test scores of the students who accessed the learning materials and their frequency of access of the learning materials can further indicate the effectiveness of the learning materials. For example, students who have relatively high test scores and who accessed certain learning materials more often than other learning materials can suggest that such learning materials should be recommended for other students.

The system for managing learning materials can be implemented by one or more networks servers connected to the various sources of learning materials. The one or more network servers can execute computer software modules to implement the management functions of the present invention, which include storing, searching, and tracking the use of the learning materials. The learning materials can be stored in one or more data repositories. Student profiles and tracking information related to a student's use of the learning materials can be stored in one or more databases. The data repositories and databases, therefore, may contain information that can be used by the search algorithm to locate recommended learning materials for each student.

Reference will now be made in detail to various and alternative exemplary embodiments and to the accompanying figures, in which like numerals represent substantially identical elements. Each exemplary embodiment is provided by way of explanation, and not as a limitation. It will be apparent to those skilled in the art that modifications and variations can be made without departing from the scope or spirit of the disclosure and claims. For instance, features illustrated or described as part of one embodiment may be used in connection with another embodiment to yield a still further embodiment. Thus, it is intended that the present disclosure includes modifications and variations that come within the scope of the appended claims and their equivalents.

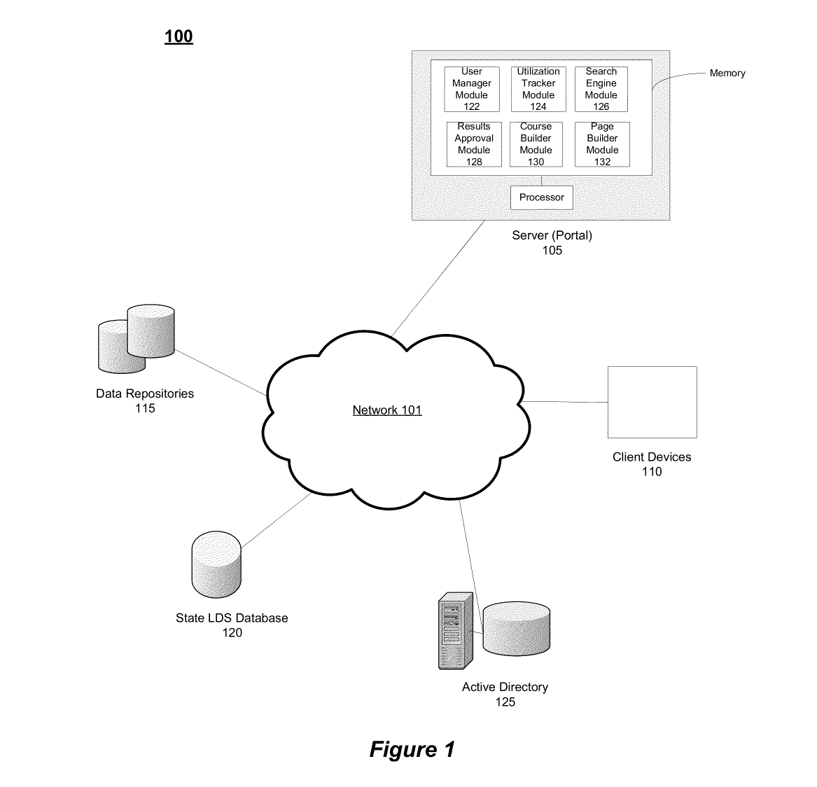

FIG. 1 depicts an exemplary system 100 for implementing a system for managing learning materials (also referred to herein as the “management system”). The exemplary system 100 can include a server 105 that can communicate with one or more data repositories 115 that store the learning materials and one or more databases 120 that store students' test scores and personal attributes. In one embodiment, all information related to students and the learning materials can be centralized in the Active Directory™ 125, with which the server 105 also communicates. The server 105 can receive requests to access the system from various client devices 110 controlled by the various users of the system. The server, databases, and devices can be connected via network 101. Various other devices can be integrated into or connected to the existing management system using the network 101.

Students, instructors, administrators, or other users can use one or more client devices 110 to access the learning materials and/or functions of the present invention. Examples of the client devices 110 include computerized devices such as personal computers (desktop and laptop), smartphones, network terminals, workstations, or other devices with sufficient computing and networking capabilities (e.g., a processor, memory, and network interface) to send and receive communications to and from the server 105 and display information received from the server 105 on a display area of the client device for the user.

The server 105 can include a network interface for connecting to other computer servers, databases, or data repositories over a network (e.g., an IP network), a memory device and hard disk for storing instructions (e.g., software code) and data, and a processor for executing instructions. Other modules or components and the basic operation of processor-driven devices are well known in the art and therefore are not discussed herein.

In an exemplary embodiment, the server 105 can act as an entry point to the Internet by providing useful content and linking to various sites on the Internet (e.g., a portal). The server 105 can display a graphical user interface that allows users to access various functions of the management system via clickable web page links, for example. In one embodiment, users may choose functions for accessing the Internet, viewing television content, searching for learning materials, and building courses or curriculums that contain certain learning materials. One or more software modules can be executed by the server 105 to implement each of the these and other functions of the management system, such as authenticating a user's access to the system and tracking a user's actions while connected to the management system.

In an exemplary embodiment, a technology that provides network services (such as user authentication) and that enables applications to find, use, and manage directory resources (such as user names and user permissions) in a distributed computing environment can be executed at a device 125. Such a technology can include a database that maintains information related to users, passwords, security, and other information on the device 125. In one embodiment, such a technology can be provided by Microsoft Active Directory™. A user can be authenticated at the device 125 based on the user's unique identification and password to determine whether the user can access the management system and if so, which functions the user has permissions to access. For example, in one embodiment, students may access the search function to locate recommended learning materials for themselves only but may not access the research or course builder function, which can permit the user of the function to see information for all students. Instructors and administrators, however, may access the search function to locate learning materials for various students and may access the course builder function to create classes or curriculums for their students. Certain other functions may be accessible only to administrators. Various permissions may be established at the group level (e.g., students, instructors, and administrator) or at the individual level (e.g., by user identification).

The data repositories 115 can be updated with electronic learning materials from various sources. In one embodiment, one or more data repositories can be populated with particular learning materials that are selected by the management system of the present invention. For example, the server 105 can execute one or more software modules to locate and upload learning materials to these data repositories (i.e., homegrown data repositories). In another embodiment, data repositories that are managed by external systems can be used. Access to such data repositories can be available to the public while some may require the purchase of a license. An example of a public data repository is one maintained or controlled by a public library. Examples of licensed data repositories can include those maintained or controlled by subscription-based services such as Westlaw® and LexisNexis®. Essentially, any device that can store learning materials electronically and that can be accessed over a network can constitute one of the data repositories 115.

In one embodiment, database 120 can store data related to various users of the management system. For example, it can store personal attributes and test scores for each student. It can also store information related to instructors, courses, or generally any data associated with an institution's resources (e.g., persons and learning materials). Persons can include any users of the system, such as students, instructors, and administrators. Information associated with learning materials can include the user identification of the instructor who created a particular learning material, the number of times learning materials were accessed by students, and the duration of the access.

Information for resources located across various institutions can be included in the database 120. In one embodiment, the database 120 is a state Longitudinal Data Server (LDS) that includes data related to resources within a state. In another embodiment, data for institutions across multiple states can be stored in the database 120. The database 120 can also store curriculum standards, which can be used to standardize test scores across the various institutions. By applying curriculum standards, the present invention can, for example, equalize a test score of an A at one institution with a test score of a B at another institution. Such equalization can allow students at various institutions to be compared so that students within a peer group can span beyond a single institution and ultimately provide a student with more recommended learning materials.

In an exemplary embodiment, the server 105 can execute a utilization tracker module 124 to monitor and record details related to a user's actions while using the management system. In one embodiment, such actions can include authenticating, selecting functions provided by the management system (such as searching, course building, and accessing the Internet), and viewing the learning materials. In other embodiments, any action by the user that triggers an event or response from the server 105 can be recorded. To accomplish such recordation, the utilization tracker module 124 can be executed by the server 105 such that it runs constantly as a background process collecting user activity data for all users using the management system. As an example, for a student who desires to locate recommended learning materials, details can be recorded related to the student's authentication (e.g., time of authentication, IP address of client device), the student's selection of the search function, the location of the learning materials (indicated by the combination of a network address, directory path, and file name associated with the learning materials), and the number of times the learning materials were accessed.

The utilization tracker module 124 can store the recorded data in a memory, database, hard disk, removable storage device, or otherwise any device capable of storing data that can be accessed by other software modules or devices. In one embodiment, the data is stored in a relational database such that user information that is stored in the database 120 and the database residing on the device 125 can be linked with the actions a user performed while connected to the management system. For example, a database record in the relational database can include a student's user identification, test scores, and personal attributes (obtained from the device 125), as well as the learning material accessed by the student, the duration of the access, and the location of the learning material (obtained by the utilization tracker module 124). In another embodiment, the utilization tracker module 124 can store the data in the Active Directory™ 125, where all information for the management system can be stored. Under either embodiment, the search algorithm can access either data source for determining which learning materials to select, as will now be discussed in detail.

In one embodiment, students can use the search engine module 126 to locate the recommended learning materials to help them improve in a particular course subject. A link corresponding to the search function can be displayed on the graphical user interface at the server 105. Upon selecting this link, students can have the option to specify certain criteria or parameters to narrow the search for learning materials. A graphical user interface (GUI) or a command line interface that supports structured query language (SQL) can be used in various embodiments to receive the search parameters at the server 105.

The search engine module 126 may be configured to provide a single search interface to any number of search engines or repositories. For example, a K-12 school district's server system may include a search aggregation engine to leverage a local media portal repository with one or more internet search engines, and with any number of repositories of licensed educational content. In embodiments, an exemplary search aggregation engine may query the associated repositories, such as data repositories 115 shown in FIG. 1, using one or more intranet and/or internet search engines from a single interface and return filtered, or unfiltered, results to a unified interface.

In embodiments, the search engines and/or repositories accessed during a given search may be regulated according to individual or group permissions. For example, certain users may be assigned access to, or select, particular search engines from among a plurality of available intranet and/or internet search engines. Results returned from an aggregated search may also be filtered according to individual and/or group permissions and/or settings. For example, resources, such as links, repository items, etc., may be assigned attributes that may be compared to individual and/or group permissions and/or settings associated with a given search, whereby certain users may be provided different results for searches of similar content. In embodiments, attributes of the resources may serve to allow or disallow access to the resource by groups or individuals and/or may be used in screening out learning materials that the user is, or is not, authorized to access. This can be beneficial in various ways, e.g. showing a user only those resources that they are authorized to access, or showing resources that the user may need additional permissions to access. In embodiments where currently inaccessible results are returned to a user, the search results may include information and/or automated tools such as hyperlinks etc., to direct the user to the permission authority for the resource. For example, if an instructor maintains control over access to a particular resource, a search result listing that resource may include a hyperlink for e-mailing the instructor to request access, or, if the resource is a library that the user is not currently authorized to access, the search results may include a hyperlink, or other information, to assist the user in obtaining a library card for that library.

Resource, search and/or user attributes may be assigned, for example, as a result of active input by certain users (e.g. an “I like” or “I don't like” attribute), whereby searches for similar subject matter may return different results to different users based upon attribute comparison. Attributes may also be assigned by passive input (e.g. an instructor may assign a resource to an individual or user group which, in-turn, “allows” that content to be viewed by the individual or user group). Thus, a search by a member of a designated individual or user group might successfully return a resource link, which would have otherwise been restricted from the individual or user group. Activating various passive attribute assignments may therefore be beneficial in allowing specific resources to pass search filtering to particular users, groups and/or subgroups.

Search parameters can vary by type of user, as can be defined by the user permissions in the Active Directory™ 125. For example, students can specify search parameters such as course subject or any number of personal attributes, such as such as age, race, gender, primary and secondary language, and grade level. By specifying personal attributes, students can attempt to locate learning materials that are used by students who belong to their same peer group (students who have similar personal attributes) and who have higher test scores. In one embodiment, the personal attributes can be specified by default according to the information stored in the Active Directory™ 125 for each student. In another embodiment, students may be able to select and change any number of personal attributes to further customize their search for learning materials. For example, a fifth grade student may be interested in selecting learning materials used by fourth grade students. To accomplish this, the student may change the grade level parameter from its default of “fifth grade” to “fourth grade” by using a drop-down list of choices or by overwriting the grade level in a text box. As another example, test scores can be specified by default (as stored in database 120) or they can be entered by the student. Test scores can be used to rank the list of learning materials according to students who obtained the highest test scores, without revealing the identity of the students. Each learning material that is returned in the search results can include an indicator that illustrates whether the learning material was used by students with test scores that are higher, the same, or lower than the student who is searching for learning materials. In some embodiments, a student may select a filter so that only those learning materials used by students who have higher test scores are returned.

Furthermore, students can have the search option to specify whether the student's test scores should be compared to those of other students based on the mean, median, or other mathematical functions. Students can also filter the selection of learning materials so that only those learning materials used by students whose test scores fall within a user-specified standard deviation of the mean test score are returned. Students may also specify the date range used to compute the mean or median of the test scores. For example, if the student's mean test score was lowered due to the student's performance during a time of illness within a term, the student may specify the date range corresponding to the time of illness so that only the student's test scores during the specified date range will be compared to the test scores of other students during the same date range. Hence the ranking or filtering of the learning materials can be adjusted according to performance over a specified period. A number of other filtering or search techniques can be provided to allow users to further customize the selection of learning materials.

In another embodiment, students may search for learning materials independent of the student's grades or association with a particular peer group. For example, students may enter search parameters to retrieve all learning materials created for a particular course subject or topic within the subject. Students may further filter such a list of learning materials based on the number of viewings by other users. As another example, student may filter the list based on average test scores of students who used the learning materials. Various other filters or parameters can be implemented to further narrow or customize the search results.

In addition to students, instructors and administrators can also use the search function. Additional search parameters may be available for these users that are not available to students, as determined by the permissions stored in the Active Directory™ 125, according to some embodiments. For instance, instructors may have access to a search parameter to specify one or more students for whom learning materials or personal information is sought. Instructors may use this information to create classes or lesson plans for the students. In one embodiment, instructors may develop customized classes that can each contain different recommended learning materials for each of their students. Administrators may have access to a search parameter for locating information related to one or more instructors. In one embodiment, administrators may search for learning materials authored by any instructor, the number of students who accessed the learning materials, and the number of times those students have accessed the learning materials. Such a search can be indicative of an instructor's performance relative to other instructors regarding educating students (e.g., the more students who are using an instructor's learning materials, the more valuable the instructor can be regarded). Administrators may also view the test scores of the students who accessed an instructor's learning materials to further indicate an instructor's value (e.g., students who have relatively high test scores and who use an instructor's learning materials can indicate that the instructor prepares useful learning materials). The described hierarchical search permissions (administrators searching for information related to instructors and students, instructors searching for information

After the search parameters have been specified, the search engine module 126 can locate learning materials for the user. In one embodiment, the search engine module 126 can implement an algorithm to help students locate recommended learning materials for a specified course subject. To accomplish this, the management system of the present invention can rely on personal attributes and test scores of all students to determine a peer group for a student who is in need of assistance. The personal attributes are stored in a profile for each student and compared with other students. The test scores of students in the peer group can be used to rank the learning materials according to a student's performance such that the learning materials used by the best performing students are ranked higher than other learning materials.

The profiles used to locate the learning materials can be prepared by the user manager module 122, which can be executed by the server 105. The user manager module 122 can access the personal attributes, test scores, and other user data found in the student profiles from the Active Directory™ 125 or one or more databases containing information used to create the profiles for each student. Each student profile can be assigned to a peer group by the user manager module 122. In one embodiment, each and every personal attribute in a student profile can be compared to the same personal attribute in the profiles belonging to every other student. Such a comparison attempts to define a group of students who learn the same way or who generally possess similar learning traits or attributes. Accordingly, a weighting can be assigned to each profile based on a comparison of the personal attributes. In an exemplary embodiment, a match on certain personal attributes can carry greater significance than a match on others if those personal attributes are considered to be more indicative of a similar background or learning trait than other personal attributes. The significance of the match can be defined by administrators or other users with sufficient control over the management system. As an example, in an embodiment where greater significance is placed on primary language than grade level, student profiles that match on primary language but not on grade level can receive a higher score (e.g., 2.0) than scores for profiles that match on grade level but not on primary language (e.g., 1.0). Similarly, profiles that match on grade level but not on place of birth can receive a higher score (e.g, 1.5) than scores for profiles that match on place of birth but not grade level (e.g., 0.5). It may be determined further that a combination of matches on grade level and place of birth can be less significant than a match on primary language (summed score of 1.5 vs. 2.0). Thus, according to the above example where profiles comprise the attributes of primary language, grade level, and place of birth, students having profiles that match on primary language can be assigned to the same peer group. In other embodiments, a threshold score can be set and students whose profile score is this threshold can constitute a peer group. Numerous other comparisons can be made and thresholds set to determine which students should comprise a peer group. Furthermore, pre-defined scores can be defined in the instance of a match on a particular personal attribute. Additionally, similar but not identical personal attributes can receive a score. For example, profiles having a grade level of 5 instead of a grade level of 4 can receive a score of 0.8 instead of 1 (which can denote an identical match). Studies can be used to accomplish such scores or rankings or, alternatively or additionally, administrators can assign such values according to their knowledge and/or experience. The example above is not meant to be limiting in any way. Any number or type of personal attributes can be used in a profile and any combination of comparisons between those attributes can be made.

According to one embodiment, the scores or rankings assigned to the student profiles in a peer group can be adjusted according to the student's test scores in a particular course subject. Profiles that contain higher test scores can receive higher weightings relative to the test scores of the target student. Consider the example where a student with a C grade average in Geometry needs additional assistance in Geometry. This student's grade average can be compared to that of other students in the peer group who are also enrolled in Geometry. Profiles of students who have an A course average can, for example, receive a weighting of 1.5; profiles of students who have a B course average can receive a weighting of 1.3; and profiles for students who have a D course average can receive a weighting of 0.8. Under such a scenario, students who have an A course average can be considered “recommended students.” Different thresholds can be set to determine the recommended students in other embodiments. For example, a threshold can be set such that students who have a B course average and higher are considered recommended students. In the event that no student in the peer group has performed satisfactorily based on a particular threshold, a broader search can be run to locate students in the peer group who have a lower scoring or ranking based on personal attributes but who have test scores that meet the threshold. Generally, selecting the recommended students can be a balance between a comparison of test scores and personal attributes. In one embodiment, the scores based on similarity of personal attributes and test scores can be averaged. In other embodiments, a different mathematical function can be performed to determine the overall scoring. Still in other embodiments, performance data other than test scores can be used to help determine the recommended students.

In order to compare test scores between students attending different institutions (because each institution can have different standards for testing and grading performance), curriculum standards can be stored in the database 120 or Active Directory™ 125, according to some embodiments. These curriculum standards can be used to equalize test scores across the institutions so that students' test scores have the same meaning (i.e., an A at one institution requires the same effort as an A at another institution). Thus, curriculum standards can be used to broaden a student's access to learning materials to include those learning materials used by students at any institution included in the management system of the present invention. Numerous considerations can be made to equalize test scores, including difficulty of tests as indicated by class averages, knowledge requirements to receive each test score, or any other factor that can influence a student's test scores.

The user manager module 122 can create student profiles prior to a user performing a search for learning materials, according to one embodiment. Such an action can be scheduled at a certain time each day or may be triggered based on an event (e.g., the availability of new test scores in the database 120). Student profiles may be stored in the relational database or Active Directory™ 125 with an indication of all other profiles belonging to students who are members of the peer group. Student rankings based on test scores for each course subject may also be stored. Thus, according to one embodiment, the information required to determine which learning materials to select for a target student is predetermined (i.e., the recommended students). The user manager module 122 has, according to this embodiment, retrieved the personal data, created the profiles, ranked the profiles to determine the recommended students in every course subject in which students receive one or more test scores, and stored this information in a database or other storage system. In another embodiment, such actions performed by the user manager module 122 can be performed upon a user's request to perform a search. According to this embodiment, the search engine module 126 can call (i.e., make a software function call) the user manager module 122 to create, rank, and store the student profile data.

The learning materials used by the recommended students can be accessed by the search engine 126 at the one or more data repositories 115. The learning materials can be parsed by the search engine 126 to determine their relevance to the course subject or topic searched for by the student in need to determine which of the learning materials should be the recommended learning materials. The search engine 126 can assign a score or ranking to the learning materials based on their relevance. In an exemplary embodiment, an algorithm can be used to determine the relevance of the learning materials based on the emphasis given to keywords and the location of the keywords. For example, to locate learning materials related to Geometry, the keywords “triangle” and “parallelogram” can be searched in the meta data, text, annotation, or other locations of files corresponding to the learning materials. A higher score can be assigned to keywords found in meta data than those found in an annotation or in the text of the file (i.e., based on location). Additionally, keywords that are bolded and/or underlined can receive a higher score than the same keywords that are neither bolded nor underlined (i.e., based on emphasis). Certain keywords can also receive a higher score than others based on a particular topic. For example, if the target student is having more difficulty with the Geometry topic of polygons (as can be indicated in the Active Directory™ 125 by a breakdown of test scores by course subject and topic area), the keyword “triangle” can be assigned a higher score than that of “circle” because a circle is not a polygon. Scores of recommended learning materials can be computed in similar fashion to those computed for the profiles of students in determining the recommended students in a peer group. In one embodiment, the recommended learning materials can be further filtered based on the number of times students accessed them. Therefore, learning materials can be ranked according to the performance of the students who used them, their relevance, and the number of hits they received. Various other ranking and scoring methodologies, algorithms, keywords, or other criteria can be used to determine the recommended learning materials in other embodiments.

The server 105 can execute a results approval module 128 to validate search results. Various checks can be instituted to validate the search results. In one embodiment, the results approval module 128 can cross-check the search results against the data stored in the Active Directory™ 125. In another embodiment, the search results can be manually reviewed and approved before they are made available to the user.

In one embodiment, the search engine module 126 can return the recommended learning materials as clickable links on a web page that are sorted by relevance. A user may view the learning materials by clicking on the link associated with the learning material. The search results represent the recommended learning materials (e.g., the learning materials used by the recommended students, who are the students who have the most similar personal attributes to the target student and who have the highest test scores).

Students who use learning materials managed by the present invention may access a ratings source, such as social news website, to rate the learning materials that they used. In one embodiment, such a ratings source can be Reddit. Thus, the rating of the learning materials can also be specified as a search parameter. In particular, a user may specify that the search engine 126 only locate learning materials that have received at least a certain rating by its users.

Administrators or instructors may access the course builder module 130 at the server 105 to create a collection of classes that contain certain learning materials. Individual classes of learning materials that comprise the collection of learning materials can be created by the page builder module 132. In one embodiment, each class can contain various learning materials, such as notes, lectures, text, and articles. The page builder and course builder modules can select the learning materials based on learning

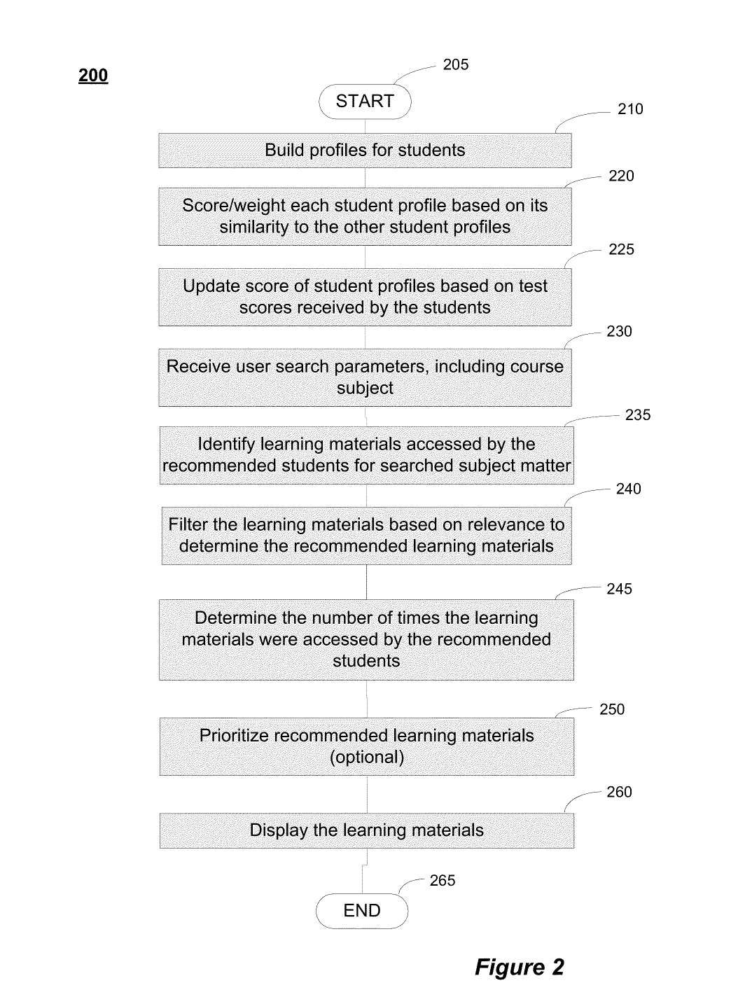

FIG. 2 is a flow diagram of the steps taken to locate the recommended learning materials according to an exemplary embodiment. Profiles containing personal attributes and test scores are created for each student at step 210. The personal attributes in the profiles of each student can be compared and scored based on their similarity to each other to determine a peer group for each student (step 220). As previously described, each personal attribute in the target student's profile can be compared to the same attribute in other students' profiles to determine the similarity between the profiles. The score or ranking can be updated based on the test scores of the students in the peer group to determine the recommended students (step 225).

At step 230, a user can specify search parameters, including course subject, to locate the recommended learning materials for the specified course subject. The user may also specify a particular topic within a course subject for which to find learning materials, in some embodiments. As previously discussed, numerous other search parameters may be specified. The learning materials accessed by the recommended students can be identified at step 235. The learning materials can be scored or ranked based on relevance to determine the recommended learning materials at step 240. The recommended learning materials can also be filtered based on the number of times they were accessed by the recommended students (step 245). At step 250, search results (i.e., recommended learning materials) can be optionally prioritized or ranked according to one or more factors, such as test scores of the recommended students or the number of times the recommended learning materials were accessed by students. The recommended learning materials can be displayed for viewing at step 255. As previously described, the learning materials can be displayed as clickable web page links where each link corresponds to a respective learning material.

The management system of the present invention as described in the various embodiments can offer a scalable solution for managing learning materials. Many other modifications, features and embodiments of the present invention will become evident to those of skill in the art. For example, various systems, servers, or components not expressly described herein can be integrated into the management system to provide additional functionality and learning materials. Additionally, the software modules, and thus the functionality they provide, can be ported to multiple servers within the management system. Furthermore, software modules used to implement algorithms for selecting exemplary learning materials can be highly customizable. For example, the more personal attributes that are collected for peers across a particular region, the more customizable the learning materials can become. For example, data can be collected regarding a user's preference for duration of video lectures. Certain students, who may prefer shorter lectures, may specify that they prefer lectures that are no more than one hour. Such information can be included in a profile for the student and compared with other students with high test scores in a specified course subject who also prefer lectures that are no more than one hour. Any number of data can be collected and used to select learning materials. In this regard, selection of learning materials is highly customizable.

Accordingly, it should be understood that the foregoing relates only to certain embodiments of the invention, which are presented by way of example rather than limitation. Numerous changes may be made to the embodiments described herein without departing from the spirit and scope of the invention as defined by the following claims.

1. A method for locating recommended learning materials, the method comprising:
building a profile associated with each student, wherein each profile comprises one or more personal attributes identifying each respective student;
assigning a score to each profile associated with the student based on a similarity between the one or more personal attributes identifying the student and the one or more personal attributes identifying a target student, wherein the target student is a student for whom the learning materials are sought;
determining a peer group based on a threshold score, wherein the profiles having a score above the threshold score constitute students within the peer group of the target student, wherein the threshold score represents a similarity between the profiles of the students and the target student; and
identifying the learning materials accessed by students within the peer group.

2. The method of claim 1 further comprising:
receiving a course subject as a search parameter to locate the learning materials related to the course subject;
updating the score for each profile based on a comparison between test scores received by the students relative to the test scores received by the target student, wherein the students who received higher test scores relative to the test scores of the target student constitute the recommended students; and
identifying the learning materials accessed by the recommended students, wherein the learning materials accessed by the recommended students constitute the recommended learning materials.

3. The method of claim 2 further comprising:
scoring the recommended learning materials based on relevance of the learning materials to the course subject, wherein the relevance is determined based on the location of keywords in files associated with the learning materials and the emphasis placed on the keywords; and
displaying the learning materials, wherein the learning materials are displayed according to test scores of the recommended students, the number of times the learning materials were accessed by the recommended students, and the duration of the access of the learning materials.

4. The method of claim 3 wherein the keywords are located in the meta data, text, and annotations in the files associated with the learning materials.

5. The method of claim 2 further comprising equalizing test scores between students attending different institutions, wherein the equalizing is performed by comparing curriculum standards used at the different institutions, and wherein the equalizing ensures that a test score at one institution is comparable to a test score at another institution.

6. The method of claim 2, wherein identifying the learning materials accessed by the recommended students includes aggregating search results from a plurality of data repositories.

7. The method of claim 6, wherein identifying the learning materials accessed by the recommended students includes screening out learning materials that the target student is not authorized to access.

8. A computer readable storage medium comprising computer-executable instructions for:
building a profile associated with each student, wherein each profile comprises one or more personal attributes identifying each respective student;
assigning a score to each profile associated with the student based on a similarity between the one or more personal attributes identifying the student and the one or more personal attributes identifying a target student, wherein the target student is a student for whom the learning materials are sought;
determining a peer group based on a threshold score, wherein the profiles having a score above the threshold score constitute students within the peer group of the target student, wherein the threshold score represents a similarity between the profiles of the students and the target student; and
identifying the learning materials accessed by students within the peer group.

9. The computer readable storage medium of claim 8 further comprising:
receiving a course subject as a search parameter to locate the learning materials related to the course subject;
updating the score for each profile based on a comparison between test scores received by the students relative to the test scores received by the target student, wherein the students who received higher test scores relative to the test scores of the target student constitute the recommended students; and
identifying the learning materials accessed by the recommended students, wherein the learning materials accessed by the recommended students constitute the recommended learning materials.

10. The computer readable storage medium of claim 9 further comprising:
scoring the recommended learning materials based on relevance of the learning materials to the course subject, wherein the relevance is determined based on the location of keywords in files associated with the learning materials and the emphasis placed on the keywords; and
displaying the learning materials, wherein the learning materials are displayed according to test scores of the recommended students, the number of times the learning materials were accessed by the recommended students, and the duration of the access of the learning materials.

11. The computer readable storage medium of claim 10 wherein the keywords are located in the meta data, text, and annotations in the files associated with the learning materials.

12. The computer readable storage medium of claim 9 further comprising equalizing test scores between students attending different institutions, wherein the equalizing is performed by comparing curriculum standards used at the different institutions, and wherein the equalizing ensures that a test score at one institution is comparable to a test score at another institution.

13. A system for managing learning materials, the system comprising:
a server comprising:
a network interface for connecting to a network;
a memory for storing one or more program modules; and
a processor for executing the one or more program modules, wherein the one or more program modules comprise computer-executable instructions for causing the server to:
build a profile associated with each student, wherein each profile comprises one or more personal attributes identifying each respective student;
assign a score to each profile associated with the student based on a similarity between the one or more personal attributes identifying the student and the one or more personal attributes identifying a target student, wherein the target student is a student for whom the learning materials are sought;
determine a peer group based on a threshold score, wherein the profiles having a score above the threshold score constitute students within the peer group of the target student, wherein the threshold score represents a similarity between the profiles of the students and the target student; and
identify the learning materials accessed by students within the peer group.

14. The system of claim 13 wherein the processor further executes instructions for causing the server to track information related to the use of the learning materials, wherein the information includes a number of times that the learning materials have been accessed, a user identification of the student who accessed the learning materials, and the duration of the access of the learning materials.

15. The system of claim 13 wherein the processor further executes instructions for causing the server to build a class for one or more students, wherein the class is a web page comprising links corresponding to respective learning materials identified as the recommended learning materials for the respective students.

16. The system of claim 13 wherein the processor further executes instructions for causing the server to:
receive a course subject as a search parameter to locate the learning materials related to the course subject;
update the score for each profile based on a comparison between test scores received by the students relative to the test scores received by the target student, wherein the students who received higher test scores relative to the test scores of the target student constitute the recommended students; and
identify the learning materials accessed by the recommended students, wherein the learning materials accessed by the recommended students constitute the recommended learning materials.

17. The system of claim 16 wherein the processor further executes instructions for causing the server to:
score the recommended learning materials based on relevance of the learning materials to the course subject, wherein the relevance is determined based on the location of keywords in files associated with the learning materials and the emphasis placed on the keywords; and
display the learning materials, wherein the learning materials are displayed according to test scores of the recommended students, the number of times the learning materials were accessed by the recommended students, and the duration of the access of the learning materials.

18. The system of claim 17 wherein the keywords are located in the meta data, text, and annotations in the files associated with the learning materials.

19. The system of claim 16 wherein the processor further executes instructions for causing the server to equalize test scores between students attending different institutions, wherein the equalizing is performed by comparing curriculum standards used at the different institutions, and wherein the equalizing ensures that a test score at one institution is comparable to a test score at another institution.

20. The system of claim 13 wherein the processor further executes instructions for causing the server to communicate with a ratings source comprising ratings assigned to the learning materials by students who accessed the learning materials, wherein the ratings are used to filter the learning materials accessed by the students in the peer group.

21. A method comprising:
selecting learning materials created by one or more instructors, wherein the one or more instructors assign test scores to students who access the learning materials;
weighting the learning materials based on: the number of times the learning materials were accessed by students and the test scores of the students who accessed the learning materials; and
identifying the instructors who created the learning materials.

22. The method of claim 21 further comprising communicating with a ratings source comprising ratings assigned to the learning materials by students who accessed the learning materials, wherein the ratings are used to filter the learning materials created by the instructors.
